(19) United States
(12) Patent Application Publication
(10) Pub. No.: US 2009/0165032 A1
(43) Pub. Date: Jun. 25, 2009

(54) Method And Apparatus For Managing Broadcasting Services Using Broadcast Tokens

(75) Inventors: Rodney Burke, Cantonsville, MD (US); Steven Andrew Johnson, Ellicott City, MD (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(73) Assignee: iBiquity Digital Corporation, Columbia, MD (US)

(21) Appl. No.: 11/963,049

(22) Filed: Dec. 21, 2007

(51) Int. Cl. H04N 7/16

(52) U.S. Cl. 725/23

(57) ABSTRACT

A method of managing radio broadcasting services includes: generating a broadcast token including information for associating a service with one or more subscriber groups, using the broadcast token to configure a transmission of the service by a broadcaster, and broadcasting the service to the subscriber group. At the broadcaster, the service can be configured by using parameters in the broadcast token to retrieve service content from a resource manager.

### FIELD OF THE INVENTION

This invention relates to broadcasting systems and, more particularly, to methods and apparatus for managing the delivery of broadcasting services using broadcasting tokens.

### BACKGROUND OF THE INVENTION

The iBiquity Digital Corporation HD Radio™ system is designed to permit a smooth evolution from current analog Amplitude Modulation (AM) and Frequency Modulation (FM) radio to a fully digital In-Band On-Channel (IBOC) system. This system delivers digital audio and data services to mobile, portable, and fixed receivers from terrestrial transmitters in the existing Medium Frequency (MF) and Very High Frequency (VHF) radio bands. Broadcasters may continue to transmit analog AM and FM simultaneously with the new, higher-quality, and more robust digital signals, allowing themselves and their listeners to convert from analog to digital radio while maintaining their current frequency allocations.

The HD Radio system allows multiple services to share the broadcast capacity of a single station. One feature of digital transmission systems is the inherent ability to simultaneously transmit both digitized audio and data. Thus the technology also allows for wireless data services from AM and FM radio stations. First generation (core) services include a Main Program Service (MPS) and the Station Information Service (SIS). Second generation services, referred to as Advanced Application Services (AAS), include new information services providing, for example, multicast programming, electronic program guides, navigation maps, traffic information, multimedia programming and other content.

The HD Radio system provides a platform for the delivery of a wide range of services, both audio and data. However, in order to efficiently manage the services, there is a need to identify and associate the services and the characteristics of the services with the service providers. In addition, subscription-based services for HD Radio programming based on conditional access require the ability to uniquely identify and describe the service providers and their service offerings.

### SUMMARY OF THE INVENTION

In a first aspect, the invention provides a method of managing radio broadcasting services including: generating a broadcast token including information for associating a service with one or more subscriber groups, using the broadcast token to configure a transmission of the service by a broadcaster, and broadcasting the service to the subscriber group. At the broadcaster, the service can be configured by using parameters in the broadcast token to retrieve service content from a resource manager.

### BRIEF DESCRIPTION OF THE DRAWINGS

FIG. 1 is a block diagram of a transmitter for use in an in-band on-channel digital radio broadcasting system.

FIG. 2 is a schematic diagram that illustrates functional relationships among various entities and an HD Radio system capable of broadcasting conditional access signals.

FIG. 3 is a block diagram of a service registry.

FIGS. 4a and 4b are a schematic diagram that illustrates the exchange of information among various entities in a broadcasting system.

FIGS. 5a, 5b and 5c are a schematic diagram that illustrates the information that may be exchanged among various entities and the service registry.

FIG. 6 is a diagram that illustrates broadcast token association.

FIG. 7 is a diagram that illustrates broadcast token relationships.

FIG. 8 is a diagram that illustrates conditional access service management using broadcast tokens.

### DETAILED DESCRIPTION OF THE INVENTION

In one aspect, this invention provides a method for controlling access to broadcast services using a broadcast token. The broadcast token facilitates the sharing of service metadata related to subscription-based conditional access (CA) services for an HD Radio system.

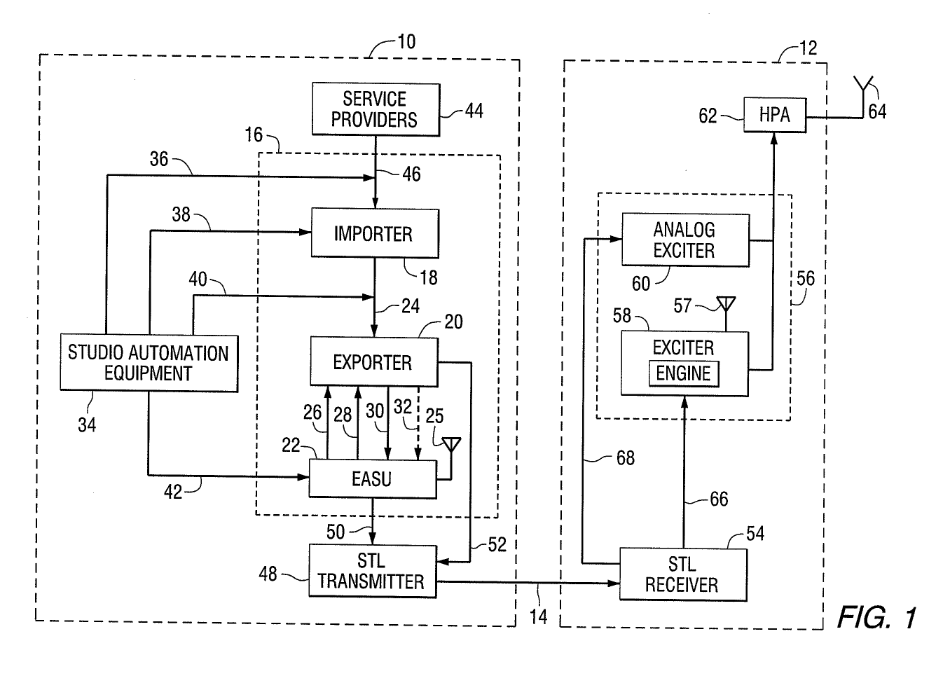

Referring to the drawings, FIG. 1 is a functional block diagram of the relevant components of a studio site 10, an FM transmitter site 12, and a studio transmitter link (STL) 14 that can be used to broadcast an FM IBOC digital audio broadcasting (DAB) signal. The studio site includes, among other things, studio automation equipment 34, an Ensemble Operations Center (EOC) 16 that includes an importer 18, an exporter 20, an exciter auxiliary service unit (EASU) 22, and an STL transmitter 48. The transmitter site includes an STL receiver 54, a digital exciter 56 that includes an exciter engine (exgine) subsystem 58, and an analog exciter 60. While in FIG. 1 the exporter is resident at a radio station's studio site and the exciter is located at the transmission site; these elements may be co-located at the transmission site.

At the studio site, the studio automation equipment supplies main program service (MPS) audio 42 to the EASU, MPS data 40 to the exporter, supplemental program service (SPS) audio 38 to the importer, and SPS data 36 to the importer. MPS audio serves as the main audio programming source. In hybrid modes, it preserves the existing analog radio programming formats in both the analog and digital transmissions. MPS data, also known as program service data (PSD), includes information such as music title, artist, album name, etc. Supplemental program service can include supplementary audio content as well as program associated data.

The importer contains hardware and software for supplying advanced application services (AAS). A “service” is content that is delivered to users via an IBOC DAB broadcast, and AAS can include any type of data that is not classified as MPS or SPS. Examples of AAS data include real-time traffic and weather information, navigation map updates or other images, electronic program guides, multicast programming, multimedia programming, other audio services, and other content. The content for AAS can be supplied by service providers 44, which provide service data 46 to the importer. The service providers may be a broadcaster located at the studio site or externally sourced third-party providers of services and content. In an aspect of this invention, the service providers supply the service data to a service registry that interfaces with the importer. The importer can establish session connections between multiple service providers. The importer encodes and multiplexes service data 46, SPS audio 38, and SPS data 36 to produce exporter link data 24, which is output to the exporter via a data link.

The exporter 20 contains the hardware and software necessary to supply the main program service and station information service (SIS) for broadcasting. SIS provides station information, such as call sign, absolute time, position correlated to GPS, etc. The exporter accepts digital MPS audio 26 over an audio interface and compresses the audio. The exporter also multiplexes MPS data 40, exporter link data 24, and the compressed digital MPS audio to produce exciter link data 52. In addition, the exporter accepts analog MPS audio 28 over its audio interface and applies a pre-programmed delay to it to produce a delayed analog MPS audio signal 30. This analog audio can be broadcast as a backup channel for hybrid IBOC DAB broadcasts. The delay compensates for the system delay of the digital MPS audio, allowing receivers to blend between the digital and analog program without a shift in time. In an AM transmission system, the delayed MPS audio signal 30 is converted by the exporter to a mono signal and sent directly to the STL as part of the exciter link data 52.

The EASU 22 accepts MPS audio 42 from the studio automation equipment, rate converts it to the proper system clock, and outputs two copies of the signal, one digital 26 and one analog 28. The EASU includes a GPS receiver that is connected to an antenna 25. The GPS receiver allows the EASU to derive a master clock signal, which is synchronized to the exciter's clock by use of GPS units. The EASU provides the master system clock used by the exporter. The EASU is also used to bypass (or redirect) the analog MPS audio from being passed through the exporter in the event the exporter has a catastrophic fault and is no longer operational. The bypassed audio 32 can be fed directly into the STL transmitter, eliminating a dead-air event.

The STL transmitter 48 receives delayed analog MPS audio 50 and exciter link data 52. It outputs exciter link data and delayed analog MPS audio over STL link 14, which may be either unidirectional or bidirectional. The STL link may be a digital microwave or Ethernet link, for example, and may use the standard User Datagram Protocol or the standard TCP/IP.

The transmitter site includes an STL receiver 54, an exciter 56 and an analog exciter 60. The STL receiver 54 receives exciter link data, including audio and data signals as well as command and control messages, over the STL link 14. The exciter link data is passed to the exciter 56, which produces the IBOC DAB waveform. The exciter includes a host processor, digital up-converter, RF up-converter, and exgine subsystem 58. The exgine accepts exciter link data and modulates the digital portion of the IBOC DAB waveform. The digital up-converter of exciter 56 converts from digital-to-analog the baseband portion of the exgine output. The digital-to-analog conversion is based on a GPS clock, common to that of the exporter's GPS-based clock derived from the EASU. Thus, the exciter 56 includes a GPS unit and antenna 57. An alternative method for synchronizing the exporter and exciter clocks can be found in U.S. patent application Ser. No. 11/081,267 (Publication No. 2006/0209941 A1). The RF up-converter of the exciter up-converts the analog signal to the proper in-band channel frequency. The up-converted signal is then passed to the high power amplifier 62 and antenna 64 for broadcast. In an AM transmission system, the exgine subsystem coherently adds the backup analog MPS audio to the digital waveform in the hybrid mode; thus, the AM transmission system does not include the analog exciter 60. In addition, the exciter 56 produces phase and magnitude information and the analog signal is output directly to the high power amplifier.

IBOC DAB signals can be transmitted in both AM and FM radio bands, using a variety of waveforms. The waveforms include an FM hybrid IBOC DAB waveform, an FM all-digital IBOC DAB waveform, an AM hybrid IBOC DAB waveform, and an AM all-digital IBOC DAB waveform.

The HD Radio system provides audio services including multicasting and data services. These services can be transported through the system and processed by the receiver with minimal metadata information and support. However, an increasingly large number of advanced data services including, for example: navigation based services, subscription audio services, automotive based services, mobile entertainment updates, and subscription/targeted data services may be implemented in the HD Radio system. These services can be implemented in scenarios where a single service provider might wish to deploy multiple HD Radio services.

There is a need for a consistent method of broadcasting services over the HD Radio system. In addition, there is a need for a method of broadcasting services over the HD Radio system that provides for consistent retrieval of these services at the receiver, and can track incremental revenue from advanced services given the wide range of advanced services that can be deployed over HD Radio.

A central repository can be used to maintain and process the HD Radio metadata elements used to describe and uniquely identify HD Radio service offerings by service providers, and to allow HD Radio receivers to uniquely identify services and provide the relevant user experience.

The service registry helps to maintain a consistent and non-duplicative set-up of services for the radio broadcast industry. For the importer, the role of the service registry includes sharing service information and global system parameters, and providing license activation. A commonly owned U.S. patent application, filed on the same day as this application and titled “Radio Service Registry” provides additional information relating to the service registry, and is hereby incorporated by reference.

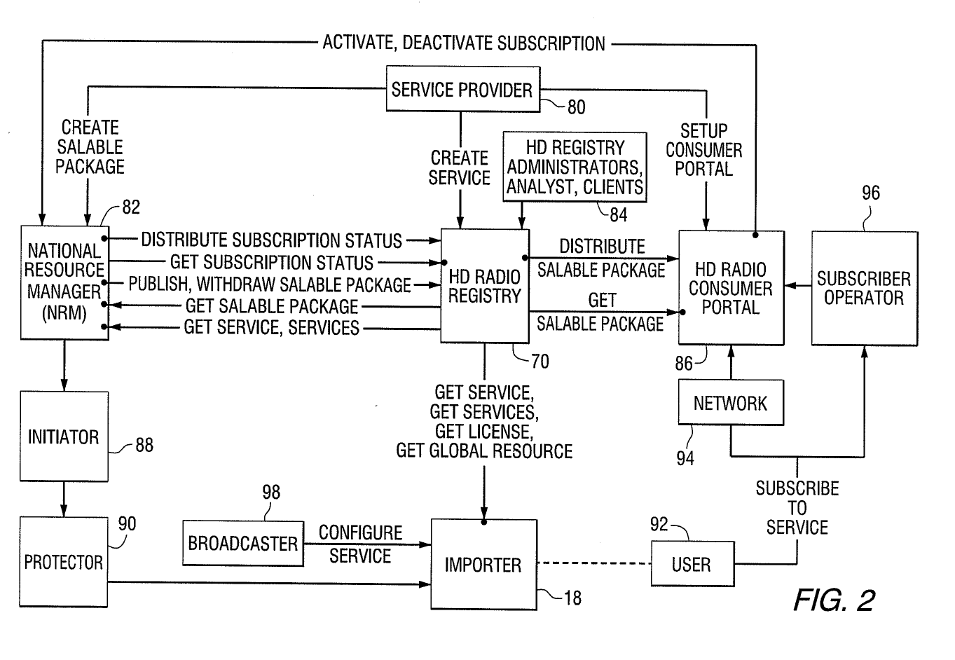

FIG. 2 is a high level block diagram illustrating the service registry 70 and the importer 18 in the broadcast system architecture. The service registry interfaces with many entities, such as service providers 80, a national resource manager 82, administrators 84, and consumer portals 86, as well as the importer 18.

Salable packages are created on the National Resource Manager (NRM) system by service providers. In practice, a service provider uses a NRM user interface to construct a salable package. In order for the salable package to be created, the NRM must obtain the service definition from the service registry. This can be accomplished during salable package construction, when the service provider enters (or selects from a list) the service ID (obtained from prior construction of service at the service registry). Once the service definition is obtained, the salable package can be created. After the salable package is created on the NRM, the NRM sends (publishes) the salable package definition to the service registry, where it is made available to other entities such as the consumer portal. “Publishing” puts a read-only copy of the salable package on the service registry for other associated entities to view (e.g., the consumer portal). The national resource manager also exchanges other information with the service registry.

A salable package is a container for grouping related salable units associated with a given service. A salable package can include multiple salable units, and a salable unit can be associated with one salable package. A salable unit is a collection of broadcast units provisioned for subscription. Subscribers are contractually bound to a salable unit. A salable unit can include multiple broadcast units, but a broadcast unit can be associated with, at most, two salable units due to bandwidth constraints defined for an HD Radio conditional access system. Broadcast units identify the concrete over-the-air content being aired over one or more stations. A broadcast unit can include: list of broadcast stations authorized to carry the content, receiver-side routing and application processing requirements, and content identity and description.

The national resource manager also receives subscription information from the consumer portal. The national resource manager exchanges information with the service registry and sends a distribution activation key to an initiator 88. The initiator transmits the key to a protector 90, which subsequently transmits the key to the importer. A user 92 subscribes to the service by either contacting the consumer portal through a network 94 or contacting a subscriber operator 96. A broadcaster 98 can also interact with the importer to configure services.

Subscription requests can be submitted to the consumer portal from a user (also called a listener or customer). The listener can interact with the consumer portal though a device that is capable of exchanging information with the subscription portal, such as a personal computer or other device. The user can use the HD Radio consumer portal to subscribe to services from service providers.

Service providers generate or provide content. The content can be conditional access content or non-conditional access content. The service registry can interface with service providers in order to register the service providers and to set up service provider accounts.

The service providers can specify service parameters that are used to define service packages. The service parameters can include service provider registration information and service metadata information.

The service registry provides a central repository of service parameters and metadata for HD Radio services. The service parameters and metadata information is supplied by the registry to the broadcaster.

Metadata can include, for example, content type, MIME basic hash, a text information descriptor/call to action, a validity descriptor, and/or the service provider name. The content type can identify the genre of the audio or data service. Multipurpose Internet Mail Extensions (MIME) is a standard that relates to message formats. The MIME basic hash can be used to associate the service provider/format with the application at the receiver.

HD Radio metadata/service parameters contain over-the-air signaling parameters sent over the HD Radio system to describe or identify a piece of content.

The metadata/service parameters are used in the set-up and broadcast of HD Radio services, and facilitate meaningful interpretation and processing at the receiver. The metadata information is used to uniquely identify and describe particular services transported over the HD Radio system.

For conditional access services, the broadcaster broadcasts an encrypted data stream that includes a decryption key needed by subscribers to decrypt services to which they are entitled. In one example, an importer at the broadcaster scrambles conditional access content, and a conditional access management system processes subscriber entitlements and provides keys for decrypting the scrambled content.

The HD Radio system provides the flexibility and capability to efficiently deliver service related metadata information from the service provider so that HD Radio receivers can quickly and efficiently discover the services broadcast over the system. Such receivers can then process the information and provide the relevant user-experience through associated application software residing at the receiver.

The service registry also allows radio broadcasters to define service offerings of their own and offers a consistent identification and transport of services over the HD Radio system. The importer combines this information with broadcast tokens received from the station administration to produce an authorized service broadcast.

In this example, the service registry has both human user and machine-to-machine interfaces. Human interfaces include service provider, broadcaster, and subscriber operator interfaces. The machine-to-machine interfaces couple the service registry to the consumer portal, the national resource manager and the importer.

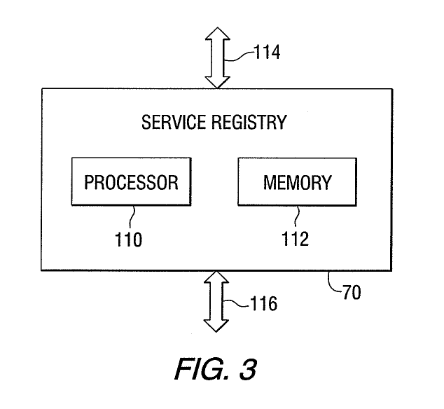

FIG. 3 is a block diagram of a service registry 70. The service registry includes a processor 110 and a memory or storage element 112. The processor exchanges information with various entities through a core interface 114 and a resource manager interface 116. The processor can be programmed to retrieve the information from the memory in response to commands received on the interfaces, and to output the retrieved information to the importer.

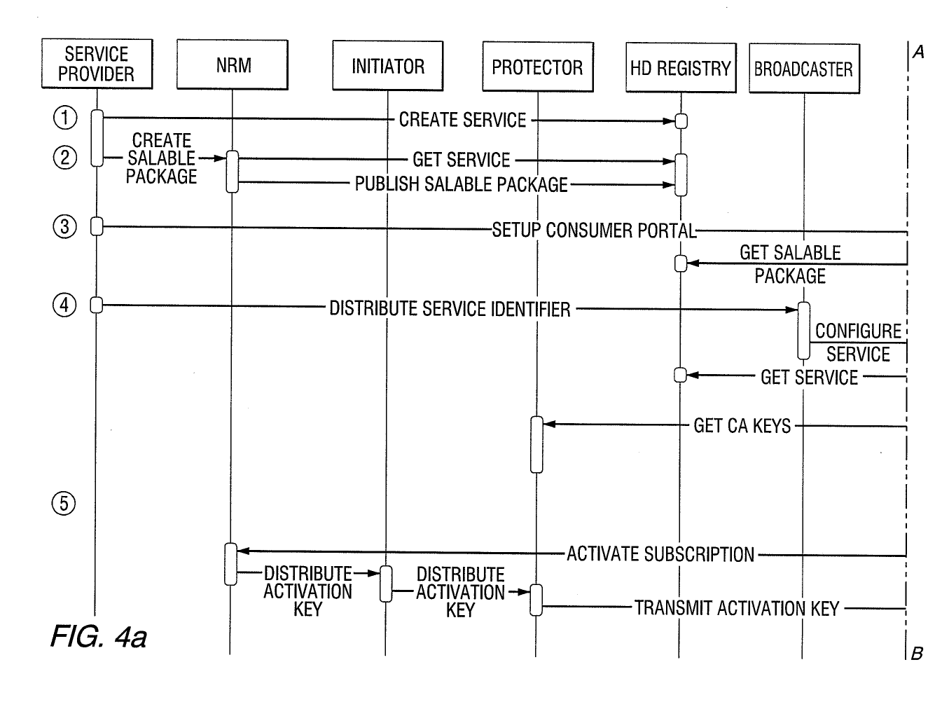

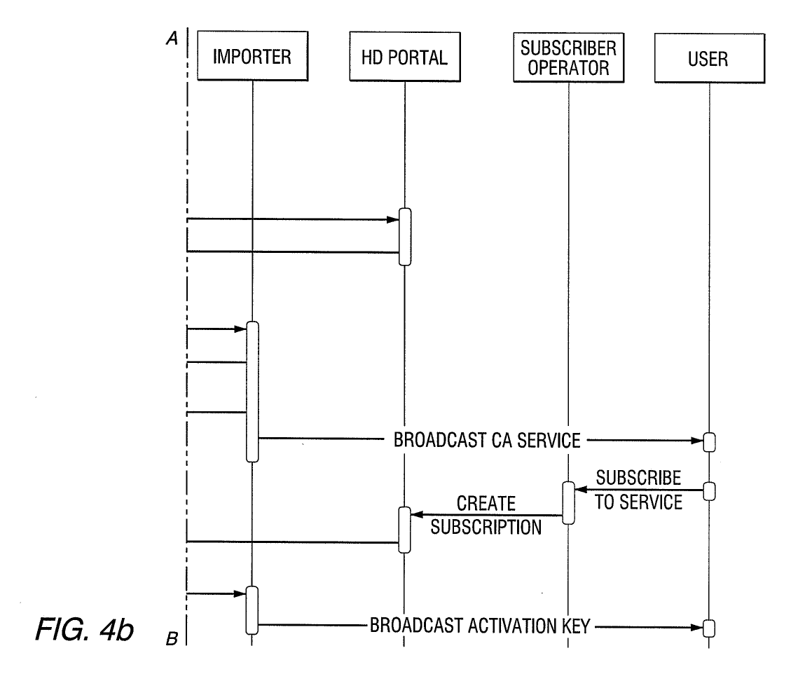

FIGS. 4a and 4b are a schematic diagram that illustrates the exchange of information among various entities in a broadcasting system. As shown in FIGS. 4a and 4b, the service provider interacts with the national resource manager to create salable packages. The national resource manager sends the salable packages to the service registry. The service is provided in salable units.

A salable package is a container for salable units, can include multiple salable units, and a salable unit can be associated with one salable package.

The service provider also supplies setup information to the consumer portal and distributes a service identifier to a broadcaster. The setup information can include service, salable package, salable unit and broadcast unit identifiers and descriptions, and point-of-sale descriptors that can include salable unit cost and availability.

The national resource manager also distributes an activation key in response to a request from the consumer portal to activate a subscription.

The broadcaster configures the service for use in combination with the broadcaster's other broadcasting services.

The importer retrieves the service packages from the service registry and retrieves conditional access keys from the protector.

A user subscribes to the service through the consumer portal, for example using either an operator or via a network. The consumer portal activates the subscription and informs the national resource manager that the subscription is active. The national resource manager distributes a subscription activation status message in response to an indication that a subscription is active.

The initiator receives the subscription-activated indication, generates an entitlement message on behalf of the activated subscriber and sends the entitlement to the protector. The protector transmits subscriber entitlement messages to the importer for over-the-air broadcast, which allows a subscriber's radio to receive the subscription content. The protector also transmits service content encryption keys to the importer to encrypt subscription service content and entitlement control messages, for over-the-air broadcast. The entitlement control message is used by radio receivers, in conjunction with the entitlement, to generate a service content decryption key for valid subscribers.

The broadcaster then broadcasts the service in encrypted form to the subscriber's radio, along with an activation key (e.g., entitlement message). The activation key is used by the subscriber's radio to decrypt the service information.

Service providers can have many services, but a service can only be associated with one service provider. A service can be associated with many salable packages, but a salable package can only be associated with one service. In general, there's a one-to-one relationship between a service and a salable package.

A salable unit can include multiple broadcast units (e.g., stations that carry a specific content item), but a broadcast unit can be associated with, at most, two salable units. Subscribers are contractually bound to a salable unit.

A subscriber can subscribe to multiple salable units and conversely, a salable unit can be associated with many subscribers. A radio ID is an identifier that identifies a particular radio receiver. A subscriber can have multiple radio IDs.

The service registry also manages broadcast tokens, which control access to the services. Many broadcast tokens can be associated with a single importer and vice-versa; many importers can use the same broadcast token.

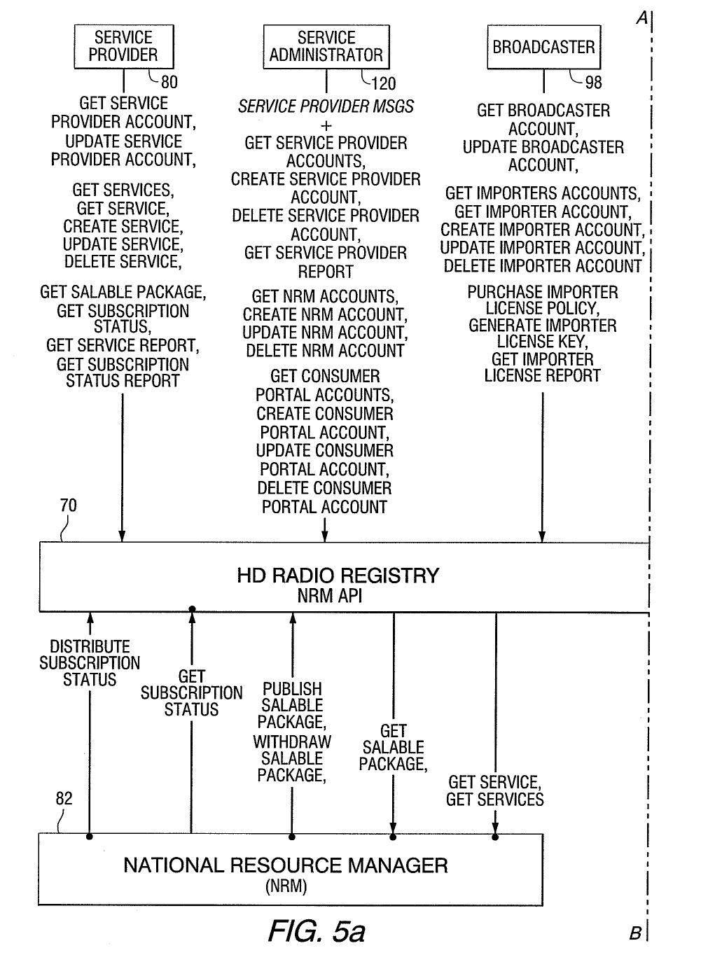

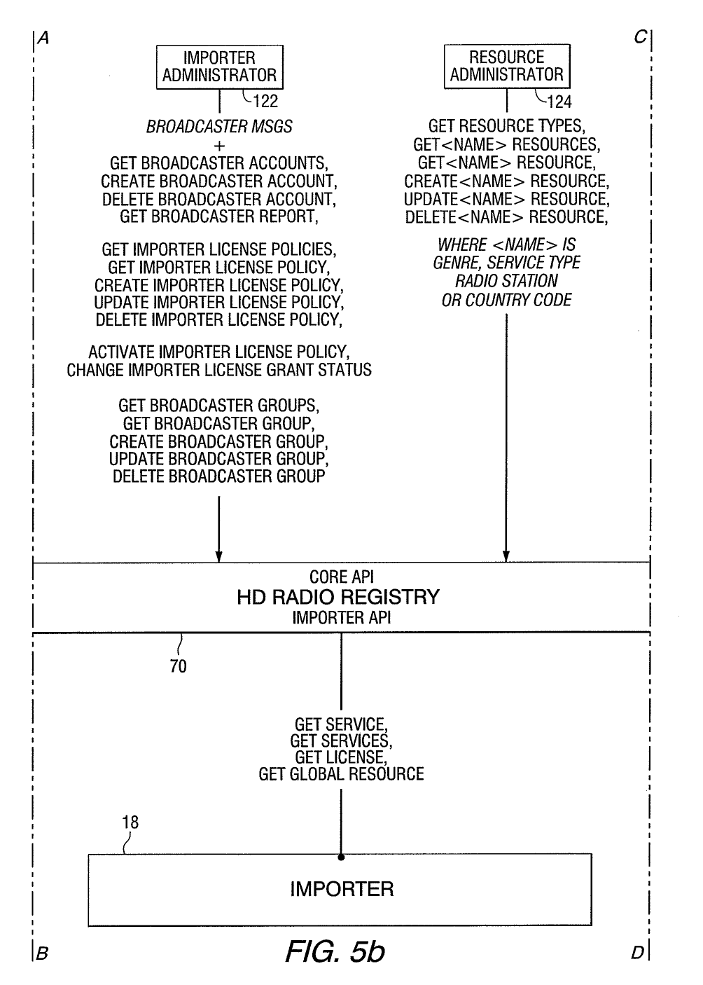

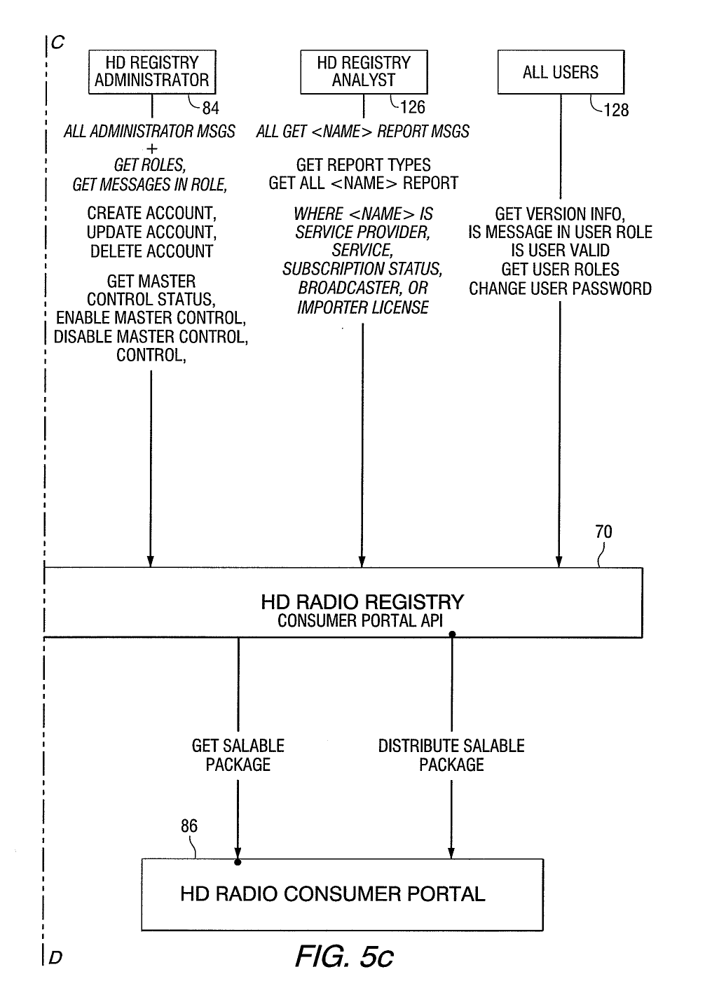

The service registry can have several types of users, such as broadcasters, service providers, administrators, and analysts. FIGS. 5a, 5b and 5c show the various users and the messages exchanged between the registry and the users.

The users include:
service providers 80—create and manage their own services
service administrators 120—manage service provider and services
broadcasters 98—create and manage their own importers
importer administrator 122—manage broadcasters and importers
resource administrator 124—manage shared resources
service registry administrator 84—power-user which manages all accounts
service registry analyst 126—generates and analyzes user and business level reports.

A separate block 128, labeled all users, identifies messages that apply to all types of users (e.g., service provider, service administrator, broadcaster, etc). All users can authenticate accounts and get registry build information.

The service registry generates and manages broadcast tokens, which control access to the services.

The broadcast tokens uniquely identify a service offering from a service provider (i.e., broadcast units). In one example, a broadcast token is a single numeric string of information that uniquely identifies content. The broadcast token is a subset of the service parameters.

The broadcast token can include any service parameters that are required to uniquely identify and describe a HD Radio service. The broadcast token structure is capable of being expanded to include any additional service parameters that may be required as the system matures. The service registry can supply the broadcast tokens to the local station upon request by the importer via the station administrator. The same broadcast token can be supplied to many local stations (importers) separated geographically to enable a centralized service offering across many stations.

The service registry can handle any dynamic changes in service offerings or salable packages from the centralized service provider. Salable packages can be defined by a broadcast station or by a content provider to be used by a number of broadcast stations. The HD Radio conditional access system provides the ability to associate services with salable packages and maintain consistency in the conditional access system.

A broadcast token is used in conjunction with the service registry to help manage not only conditional access services but also all advanced services. A broadcast token is a data word that specifies parameters relating to a broadcast service. A broadcast token allows a specific audio program or data service to be transmitted by importers and associated with one or more designated subscriber groups.

Table 1 outlines the information contained within an example broadcast token in accordance with one aspect of the invention.

TABLE 1

| Parameter | Description |
|---|---|
| Service Provider ID | A 4 character ASCII string assigned to each |
| | service provider (e.g. ‘WXYZ’) |
| Version | A number indicating the version of this token format |
| CA Level | No CA; CA, but Free to Air; CA |
| Service ID | A number labeling the specific service being |
| | provided by the Service Provider |
| Broadcast Unit ID | A number labeling the specific audio program or |
| | data service segment(s) associated with the Service |
| | ID |
| MIME Hash | A unique hash of the target application type |
| Expiration Date | A token expiration date |
| CRC | Cyclic Redundancy Check |

In one example, the cyclic redundancy check (CRC) can be computed by first converting this word to an array of N bytes (where N represents the number of bytes needed to represent the parameters listed in Table 1), computing the CRC based on the first N−2 bytes, and placing the CRC value in the token array.

In one example, the two byte CRC can either be the CRC-16, or the CRC-CCIT and are defined by the following generator polynomials:

x¹⁶+x¹⁵+x²+1; or

x¹⁶+x¹²+x⁵+1.

The token can be encrypted before being transmitted to a broadcaster. In one example, the encryption process involves the following steps: 1) scramble the token contents; 2) convert the bytes to characters; 3) scramble the characters; and 4) form the token.

To scramble the contents, a random bit string can be used as a key. This key is XORed with each bit in the token array except the ServiceProviderID. The random bit string can be generated using a linear feedback shift register with any primitive polynomial. Examples of primitive polynomials include:

P(x)=1+x²+x³+x⁴+x⁷+x⁸+x¹³

P(x)=1+x²+x⁵+x⁶+x⁸+x⁹+x¹¹

P(x)=1+x²+x³+x⁴+x⁸.

This results in an N−4-byte array. Bytes in the N−4-byte array are then converted into characters. For example, each byte can be converted into an ASCII character (G-V). In this example the byte 0x1A gets converted to the string ‘HQ’. Other mappings may also be used.

Next the characters are mapped into a larger character set by using an array of offset values to convert each character into a new character using characters stored in a character array. The offset values are predetermined random integers. The result is a set of ASCII characters representing the bytes from the token array.

Finally, the token is formed. In this example, the first 4 characters of the token are the service provider identification (ID). The remaining characters of the token can be determined by selecting characters from the character set in a predetermined but random order.

An example format for the broadcast token is then:

‘WXYZ45HJ34VE3BNLPAD29EWQBDZ9PET45NMDPS0T’.

A token is required for data services and conditional access services. Token retrieval and entry can be automated. However, the importer user interface may allow manual entry of the token.

Upon receipt of a token, the importer will perform the following tasks: 1) decrypt the token; 2) validate the token by computing the CRC and verifying it against the value in the token; 3) check the expiration date and time; and 4) verify that the MIME type hash values match. If any one of these tests fails, an error message can be generated and the corresponding broadcast unit will not be configured.

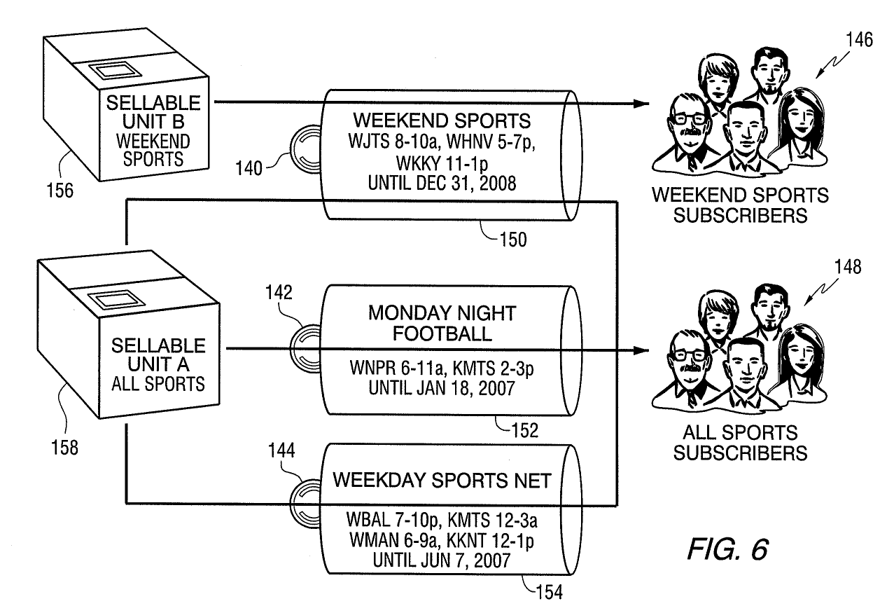

FIG. 6 is a diagram that illustrates a broadcast token association. The broadcast token allows a broadcast unit (e.g., a specific audio program segment or data service) to be associated (e.g., conditionally accessed) with one or more subscriber groups, also referred to as target groups. In FIG. 6, broadcast tokens 140, 142 and 144 allow groups 146 and 148 of subscribers to access one or more services 150, 152 and 154, that include one or more salable units 156 and 158 represented by salable unit B, weekend sports, and salable unit A, all sports.

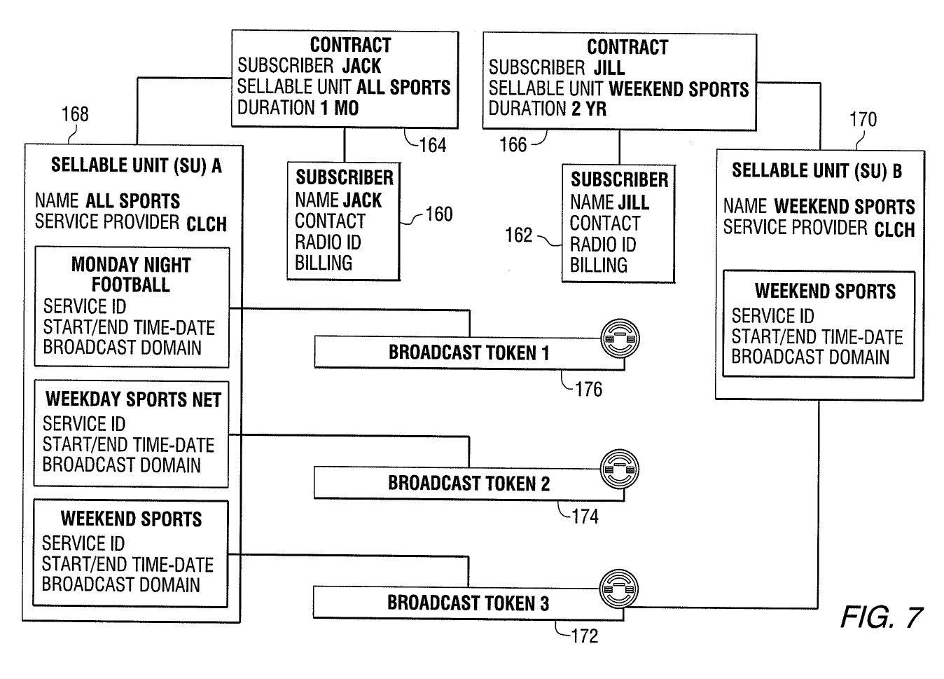

FIG. 7 is a functional block diagram that illustrates the broadcast token relationships. In FIG. 7, subscribers Jack 160 and Jill 162 enter into contracts 164 and 166, respectively, that provide for access to specific service provider salable units 168 and 170. In this example, a first salable unit (SU) 168, designated as SU A, is all sports service provider CLCH; and a second salable unit 170, designated as SU B, is weekend sports service provider CLCH. Broadcast token 172 allows both Jack and Jill to access the weekend sports unit. Broadcast tokens 174 and 176 allow Jack to access other components of the all sports unit.

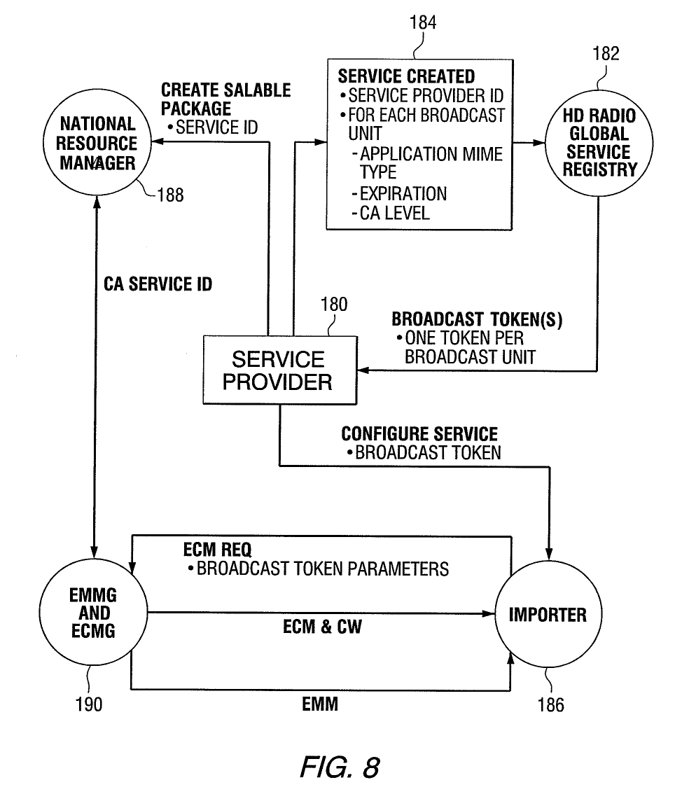

FIG. 8 is a diagram that illustrates conditional access service management using broadcast tokens. Service providers have the ability to create conditional access service, including the ability to define salable units. A service provider 180 registers with the global service registry 182 by supplying information to the service registry, including, a service provider ID and creates a service, which includes information related to each broadcast unit. The broadcast unit information 184 can include an application MIME type, a content expiration date, and other information.

The service provider content ID is an arbitrary value supplied by the service provider to identify its broadcast token request. The application MIME type identifies the target receiver application that will process the content. For example, the target receiver application could be an SPS audio processor, or a specific navigation or traffic data application. The expiration data specifies the end-of-life of the broadcast token.

The service registry generates a broadcast token. The token is passed to the service provider and an importer 186 at a broadcaster. The service provider submits a conditional access request to the national resource manager 188.

The national resource manager 188 passes the conditional access request to an Entitlement Management Message Generator (EMMG) and Entitlement Control Message Generator (ECMG) 190. The EMMG and ECMG 190 generates an Entitlement Control Message (ECM) request.

The service provider content ID is stored in the service registry, but not used in the broadcast token. The service registry generates a token serial number as part of the token format.

The service identifies a target receiver application that will process the content (e.g., SPS audio processor or specific navigation or traffic data application). The content expiration date specifies the end-of-life of the broadcast token.

The broadcast token can be encrypted so that it can be authenticated by the service registry, importer, and national resource manager system. Some fields in the token may be partially readable to allow for cursory recognition of the token owner (e.g., the service provider). The broadcast token can also serve as the content ID for a given content item within a salable unit.

While the invention has been described in terms of several examples, it will be apparent to those skilled in the art that various changes can be made to the described examples without departing from the scope of the invention as set forth in the following claims.

What is claimed is:

1. A method of managing radio broadcasting services comprising:
generating a broadcast token including information for associating a service with one or more subscriber groups;
using the broadcast token to configure a transmission of the service by a broadcaster; and
broadcasting the service to the subscriber group.

2. The method of claim 1, wherein the step of using the broadcast token to configure a transmission of the service by a broadcaster comprises:
using parameters in the broadcast token to retrieve service content from a resource manager.

3. The method of claim 2, wherein the step of broadcasting the service to the subscriber group comprises:
broadcasting an encrypted version of the service content with a key that allows decryption of the service content by subscribers in the subscriber group.

4. The method of claim 1, wherein the broadcast token comprises:
a first data field identifying service information;
a second data field including a MIME type hash identifying a target application; and
a cyclic redundancy check value.

5. The method of claim 4, wherein the cyclic redundancy check value is computed by defining a generator polynomial and dividing a group of bytes in the second data field by the generator polynomial.

6. The method of claim 5, wherein the generator polynomial is one of:
x¹⁶+x¹⁵+x²+1, or x¹⁶+x¹²+x⁵+1.

7. The method of claim 1, wherein the broadcast token is generated in a service registry and at least a portion of the broadcast token is sent to a broadcaster in encrypted form.

8. The method of claim 7, wherein the portion of the broadcast token is encrypted by:
scrambling bytes of information in the broadcast token;
converting the scrambled bytes into characters; and
scrambling the characters.

9. The method of claim 8, wherein the bytes are scrambled by:
exclusive ORing a random bit string with each bit in the bytes.

10. The method of claim 9, wherein the random bit string is generated using a linear feedback shift register with a primitive polynomial.

11. The method of claim 8, wherein the characters are scrambled by:
using an array of offset values to convert each character into a new character.

12. The method of claim 11, wherein the offset values are predetermined random integers.

13. The method of claim 8, wherein four of the characters contain service provider identification and the characters are scrambled by forming a matrix.

14. The method of claim 1, wherein the broadcast token comprises:
a service provider identification field;
a version field;
a conditional access level field;
a service identification field;
a broadcast unit identification field;
a MIME hash field; and
an expiration date field.
